(19) United States
(12) Patent Application Publication
(10) Pub. No.: US 2015/0324796 A1
(43) Pub. Date: Nov. 12, 2015

(54) DEVICE-BASED PAYMENT AUTHORIZATION

(71) Applicant: TollShare, Inc., Danville, CA (US)

(72) Inventors: Murali M. Karamchedu, Portland, OR (US); Ravi Asnani, Los Angeles, CA (US)

(73) Assignee: TollShare, Inc., Danville, CA (US)

(21) Appl. No.: 14/274,532

(22) Filed: May 9, 2014

(51) Int. Cl. G06Q 20/40; G06Q 20/32

(52) U.S. Cl. CPC G06Q 20/40; G06Q 20/322

(57) ABSTRACT

Embodiments of device-based payment authorization are described. A device-based authorization system (“DBA”) may interoperate with a device of a payer party, such as a mobile device of the payer, to facilitate authorization of a payment by the payer. The DBA may respond to a payment request, such as by a vendor, which may include a payment account number and identifying information about the payer. In response, the DBA may request authorization from the payer on a device of the payer, such as a mobile device. The DBA may send an authorization request that includes an authorization token. A payment authorization application (“PAA”) on the device may facilitate the payer in performing an authorization, such as by performing a signature. The PAA may return an authorization record, including the authorization token. The DBA may then facilitate payment from the payer to the payee. Other embodiments, may be described and claimed.

### TECHNICAL FIELD

The present disclosure relates to the field of data processing, in particular, to apparatuses, methods and storage media associated with device-based authorization of payments, such as through the usage of mobile devices.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Parties engage in financial transactions, and in particular transactions involving payment, every day. Frequently, parties seek to make payments using non-cash methods that rely upon authorization. For example, parties may seek to make payments using credit or debit cards that require an authorization, such as a signature or personal identification number (“PIN”). However, many payments systems, such as those used by credit card companies require the use of special equipment or accoutrements to perform such authorizations. For example, a credit card system that requires a signature for payments may result in a requirement for a vendor to carry paper and pens for obtaining signatures, as well as keeping the completed signatures for later review. In another example, particular equipment, such as receipt printers and/or debit PIN keypads, may be required for authorization of some payments. This can cause difficulty for vendors to accept non-cash payments, and can likewise frustrate potential customers that may wish to make non-cash payments with these vendors.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the Figures of the accompanying drawings.

FIG. 1 illustrates an example arrangement for device-based payment authorization, in accordance with various embodiments.

FIG. 2 illustrates an example process for device-based payment authorization, in accordance with various embodiments.

FIG. 3 illustrates an example process for setting up device-based payment authorization, in accordance with various embodiments.

FIG. 4 illustrates an example process for receiving a payment request, in accordance with various embodiments.

FIG. 5 illustrates an example process for requesting and receiving authorization for a payment, in accordance with various embodiments.

FIG. 6 illustrates an example process for receiving authorization for a payment, in accordance with various embodiments.

FIG. 7 illustrates an example computing environment suitable for practicing various aspects of the present disclosure, in accordance with various embodiments.

FIG. 8 illustrates an example storage medium with instructions configured to enable an apparatus to practice various aspects of the present disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” “in various embodiments,” “in some embodiments,” etc., which may each refer to one or more of the same or different embodiments. Furthermore, the terms “comprising,” “including,” “having,” and the like, as used with respect to embodiments of the present disclosure, are synonymous.

As used herein, the term “logic” and “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

In various embodiments, methods, systems, apparatuses, devices, and computer-readable media directed to device-based payment authorization are described. In various embodiments, a device-based authorization system (“DBA”) may be configured to facilitate device-based authorizations for transactions. For example, the DBA may be configured to interoperate with a device of a payer party, such as a mobile device of the payer, to facilitate authorization of a payment by the payer. In various embodiments, the DBA may respond to a payment request, such as by a vendor or other payee party. In various embodiments, the payment request may be made following entry of a credit card or other payment account number of the payer, by a payee. The request may thus include such a payment account number and identifying information about the payer, such as a mobile phone number, name, and/or other information. The request may also include information about a payee account, such as a debit/credit account or checking account, to which payment may be made.

In various embodiments, in response to receipt of the payment request, the DBA may request authorization from the payer on a device of the payer, such as a mobile device. In various embodiments, the DBA may identify the mobile device according to an account the payer maintained with the DBA. The DBA may, in some embodiments, send to the mobile device of the payer, an authorization request that includes a link, that when activated, causes the mobile device of the payer to open a payment authorization application (“PAA”). In embodiments the authorization request may be directly sent to the PAA operating on the payer's mobile device. In various embodiments, the DBA may generate an authorization token for the payment request, which the PAA may obtain prior to authorization. Upon receipt of the authorization request, the PAA may facilitate the payer in performing an authorization, such as by performing a signature on the screen of the mobile device. The PAA may then generate and return an authorization record, including the authorization token, to the DBA. The DBA may then store this authorization record. The DBA may then facilitate payment from the payer to the payee and may confirm payment with the payer and the payee. In various embodiments, this facilitation of payment may include delivery of financial information (such as account information) for the payer to the payee, so that the payee may subsequently use the financial information to perform the payment.

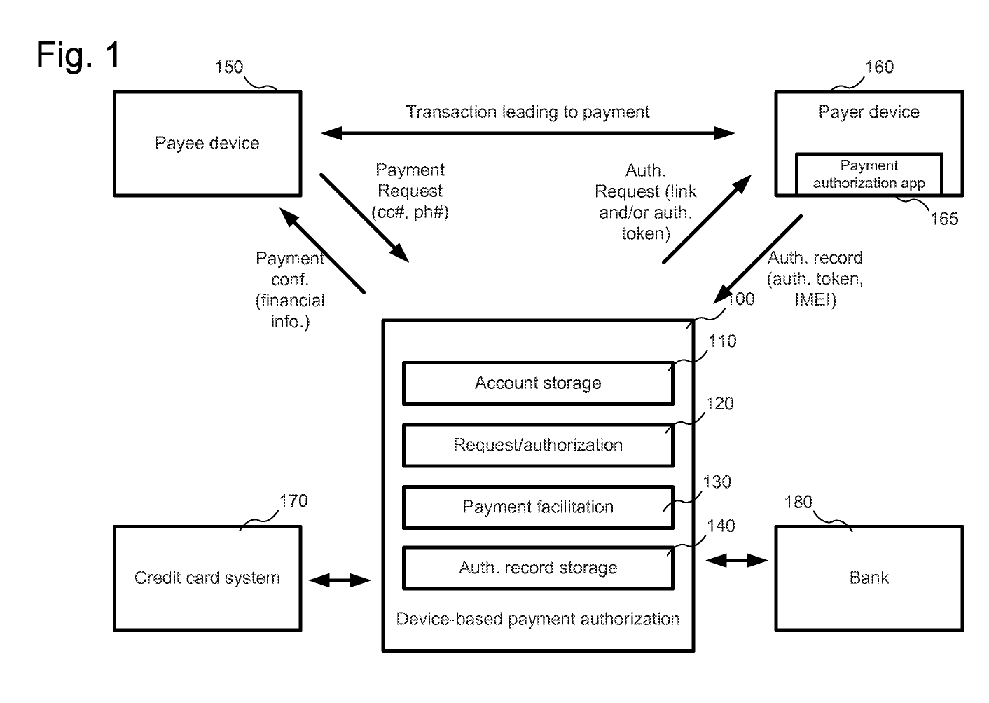

Referring now to FIG. 1, an example arrangement for device-based payment authorization may be illustrated in accordance with various embodiments. It may be noted that, while particular entities and information flows are illustrated in FIG. 1, in various embodiments, entities and modules may be omitted, split into further entities or modules, or combined, and that other information may be sent between entities.

In various embodiments, a device-based payment authorization system 100 (“DBA 100”) may be configured to communicate with a payee device 150 and a payer device 160 to facilitate payment between a respective payee and payer associated with the devices, the payee device 150, payer device 160, and/or DBA 100 may include one or more computing devices and/or computing systems, including desktop computers, laptop computers, mobile phones, tablet computers, and/or other mobile or non-mobile devices, as well as dedicated payment systems, such as credit card reader devices. In various embodiments, the payee device 150 may include various devices configured to take a payment request, such as, for example, a credit or debit card payment device. In other examples, the payee device may include a computing device configured to facilitate payment via a credit or debit card, such as a mobile device executing a credit/debit card payment application. In various embodiments, such a device may be equipped with a card reader to provide the payee the ability to swipe a credit/debit card to generate a payment.

In various embodiments, payment may be requested in following a transaction that has been performed between the payee and the payer. For example, the payee may be a vendor of goods or services, while the payer may be paying for goods or services rendered (or to be rendered). While this is illustrated, for the sake of convenience in FIG. 1, as interaction between the payee device 150 and the payer device 160, in various embodiments, it may be recognized that the actual transaction may be performed with or without the use of the one or more of the payee device 150 and the payer device 160.

In various embodiments, the DBA may be configured to receive a payment request from the payee device 150. In various embodiments, the DBA 100 may also be configured, in response to receipt of the payment request, to send an authorization request to the payer device 160. In various embodiments, the payment request and/or authorization request may include a messaging communication, such as a text message, short message service (“SMS”) message, and/or multimedia messaging service (“MMS”) message. In other embodiments, the payment request and/or authorization request may include an application programming interface (“API”) call or other programmatic call that may facilitate authorization on the payer device 160. In various embodiments, the payment request and/or authorization request may be sent via various communications protocols, including SMS or MMS protocols, other messaging protocols, such as iMessage™, or other communications protocols, such as, for example, TCP/IP communications.

The payment request may include payment information, including account information such as a credit/debit card account number of the payer, checking account number of the payer, etc., a payment amount, a description of a transaction underlying the payment, and/or other payment information. In other embodiments, the payment request may include identifying information for the payer, such as, for example, a phone number, an email address, a name, login information, etc. In various embodiments, the identifying information for the payer may be associated with the payer device 160, such as, for example, a phone number for a payer device 160 that is a mobile phone, or an email address that is associated with the payer device 160, such as for email or messaging. The payment request may also include information about the payee, such as, for example, account information such as a credit/debit card account number of the payee, checking account number of the payee, etc. In various embodiments, the payee information may be entered by the payee at the time of request, or may be known to the payee device 150 and included in the payment request automatically. In other embodiments, if the DBA has previous knowledge of account information for the payee, separate account information may not be provided as part of the payment request, but obtained from account information known to the DBA, such as information stored by the account storage 110, described in greater detail below.

In various embodiments, the payee device 150 may be configured to send the payment request at least in part in response to provision of the information into the payee device 150. In some embodiments, information such as account information may be provided to the device via a swipe of a credit or debit card of the payer through a card reader. In other embodiments one or more pieces of payment information and/or identifying information may be entered into the payee device 150, such as using a keyboard or number pad. In some embodiments, a combination of provision types may be used. For example, a vendor payee may swipe the credit/debit card of a customer through a card reader attached to a mobile device; the payee may then enter a payment amount and phone number for the payer into a number pad.

In various embodiments the payer device 160 may be configured with a payment authorization application 165 (“PAA 165”), which may be configured to facilitate authorization of a payment to the payee, by the payer. In some embodiments, such as when the authorization request includes an API call or other programmatic call, the PAA 165 may be configured to receive the authorization request from the DBA 100. In other embodiments, such as in some embodiments, where the authorization request includes a messaging communication, the PAA 165 may be configured such that it may be opened by a link, such as from a messaging communication. In some such embodiments, the authorization request may provide for such a link which may be activated by the payer (or other person using the payer device 160) to begin operation of the PAA 165.

In various embodiments, the DBA 100 may be configured to generate and provide an authorization token to the PAA 165 in order to facilitate secure authorization of the payment. In some embodiments, the authorization token may be a unique (or relatively uncommon) value associated with one or more of the particular payee, payer, and/or payment being requested. In various embodiments, the token may be provided in the authorization request in order that the DBA 100 may better trust a subsequent reply that purports to be from the PAA 165, and thus provide trust that DBA 100 only facilitates payment when legitimately authorized to do so.

As mentioned above, in various embodiments, the PAA 165 may be configured to facilitate a payer during authorization of the payment. In various embodiments, the PAA 165 may be configured to facilitate the payer in performing one or more authorization actions using the payer device 160. For example, in some embodiments, the PAA 165 may be configured to provide a facility for performing a signature on a screen or touchpad associated with the payer device 160, such as with a finger or stylus. In another example, the PAA 165 may be configured to accept a PIN, password, or other information to indicate that the payer authorizes the payment. In another embodiments, the PAA 165 may be configured to receive one or more physical gestures made with using the payer device 160, such as a three-dimensional signature.

In various embodiments, the PAA 165 may be configured to create an authorization record of the authorization. For example, if the PAA 165 provides a facility for the payer to perform a signature on the screen of the payer device 160, the PAA 165 may save a copy of an image of the signature, or data depicting a 3D signature, and so forth, to include in the authorization record. In other embodiments, the PAA 165 may save other information related to the authorization, such as authorization time, PIN or password (or a hash thereof), etc.

This authorization record may, in various embodiments, be returned to the DBA 100 to verify that the payer has authorized the requested payment. In various embodiments, the PAA 165 may also include the authorization token, if previously provided to the PAA 165, with the authorization record prior to returning the authorization record to the DBA 100. In various embodiments, the authorization record may also include an identifier of the payer device itself, such as a International Mobile Station Equipment Identity number (“IMEI number”). In various embodiments, by providing the authorization record and/or IMEI number to the DBA 100, the DBA 100 may be able to confirm that the received authorization record comes from the actual payer device 160, thereby providing additional confidence in the security of the authorization.

In various embodiments, the DBA 100 may include one or more modules for performing techniques described herein. In one example, in various embodiments, an account storage 110 (“AS 110”), which may be configured to store information about various persons or other entities, including, but not limited to, payees and payers. In various embodiments, the AS 110 may be located internally or externally to the DBA 100, and may include various techniques and implementations, as may be understood. In various embodiments, the AS 110 may include information about a payer or payer device, such as communication address/phone number information for the payer device 160 (such as to identify a payer when receiving a payment request), debit or credit account information, payment service information, etc. In various embodiments, the AS 110 may be configured to allow the DBA 100 to confirm the existence of an account for a payer based on information provided in a payment request. For example, if a phone number and credit/debit card number of the payer are provided by a payee in a payment request, the AS 110 may allow confirmation that an account exists for the indicated payer, and thus that the DBA 100 may proceed with an authorization request to the payer device. The DBA 100 may also include an authorization record storage 140 (“ARS 140”) which may be configured to store authorization records after they are received from payer devices 160. In various embodiments, the ARS 140 may be configured to provide a facility for searching for authorization records, such as to verify a purchase or other payment upon a request from a payer, payee, bank 180, credit card system 170, etc.

In various embodiments, the DBA 100 may include a request/authorization module 120 (“RA 120”), which may be configured to respond to receipt of a payment request from the payee device 150 by requesting and obtaining an authorization from payer using the payer device 160. The RA 120 may also be configured, in various embodiments, to generate an authorization request from a payee, send the authorization request to the payer device 160, and receive an authorization record in response. Techniques for requesting and obtaining an authorization record may be described below.

In various embodiments, the DBA 100 may include a payment facilitation module 130 (“PF 130”). In various embodiments, the PF 130 may be configured to interact with one or more payment entities, such as a credit card system 170 or a bank 180 to cause funds to be transferred between accounts associated with the payer and the payee. In various embodiments, the PF 130 may be configured to request debit and/or credit of one or more accounts, such as debit accounts, credit accounts, checking accounts, savings accounts, etc., which may be controlled by one or more of the credit card system 170 and/or bank 180. In other embodiments, the PF 130 may be configured to obtain financial information (such as account information) from entitles such as the credit card system 170 and/or bank 180. This information may be delivered to the payee device 150 (and thus the payee) after authorization of a payment so that the payee may subsequently perform the payment from the payer's account. Particular techniques for facilitating payment may be described below.

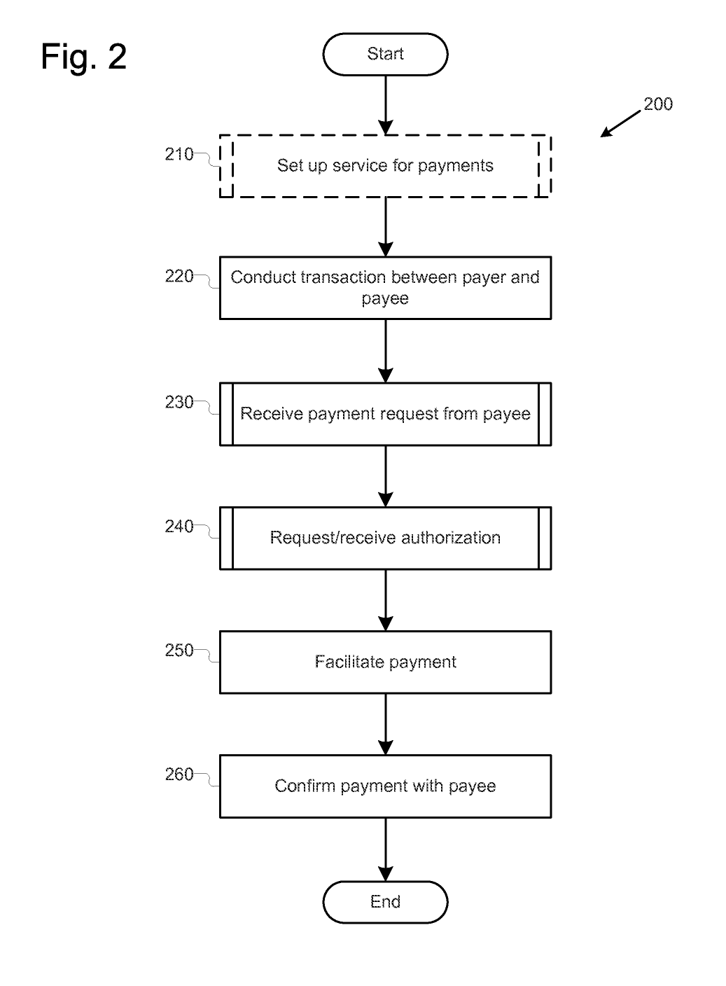

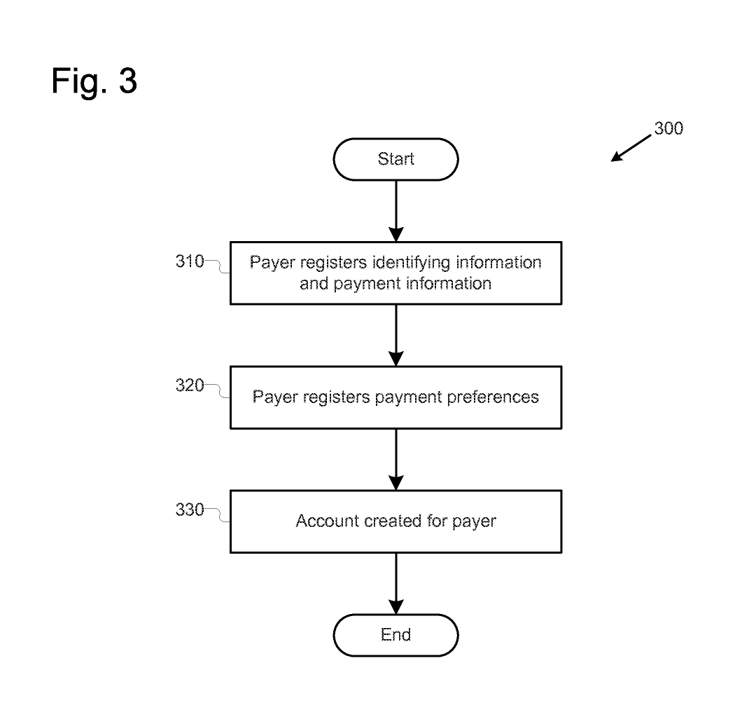

Referring now to FIG. 2, an example process 200 for device-based payment authorization is illustrated in accordance with various embodiments. While FIG. 2 illustrates particular operations in a particular order, in various embodiments, the operations may be combined, split into parts, and/or omitted. The process may begin at operation 210, where the payer (and/or payee) may, in association with the AS 110, set up payer devices 160 to be used to authorize payment (and/or payee devices 150 to request payment). Note that a device may be a payer device in one transaction, and a payee device in another. In various embodiments, operation 210 may not be performed for every payment is made, but instead may be performed prior to request and authorization of payments. Particular examples of operation 210 may be described below with reference to process 300 of FIG. 3. Next, at operation 220, the payer and payee may conduct a transaction. In various embodiments, various types of transactions may be performed without restriction on the techniques described herein. For example, transactions may include a purchase of goods, a contract for services, a gift from one party to another, etc.

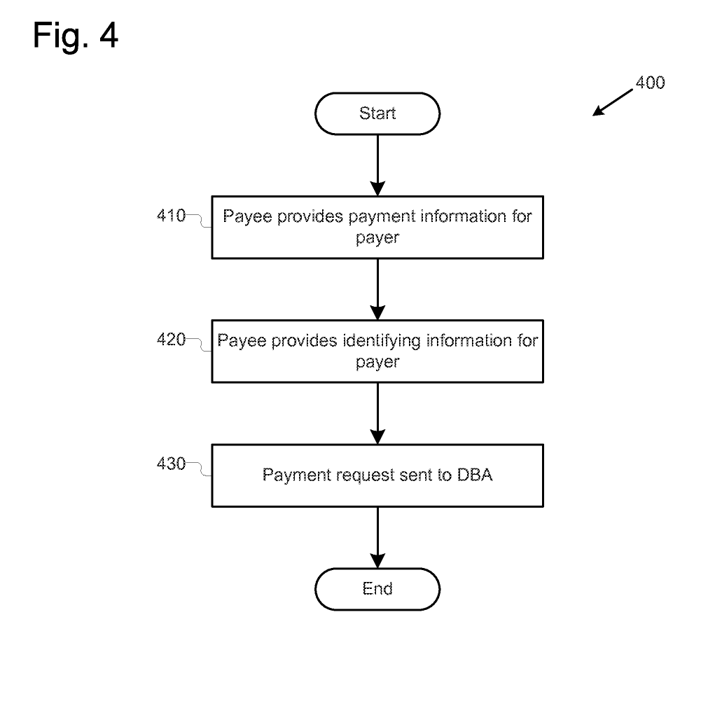

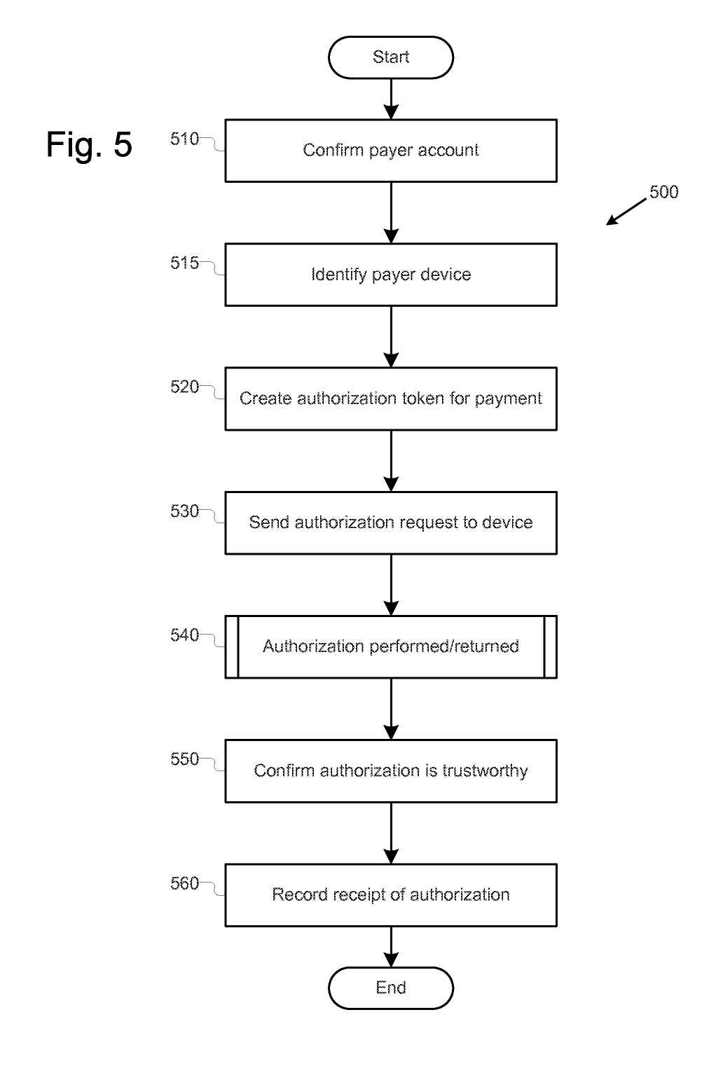

Next, at operation 230, the RA 120 may receive a payment request from the payee. For example, the payee may swipe a credit/debit card of the payer and enter a payment amount and a phone number of the payer into the payee device 150. The RA 120 may also receive an indication of a payee account, such as a debit/credit or checking account. Particular examples of operation 230 may be described below with reference to process 400 of FIG. 4. Next, at operation 240, the RA 120 of the DBA 100 may request and receive authorization of the payment from the payer. For example, the RA 120 may send an authorization request to the payer device 160 and receive, in return, an authorization record. Particular examples of operation 240 may be described below with reference to process 500 of FIG. 5.

Next, at operation 250, the PF 130 may facilitate the authorized payment. For example, the PF 130 may confirm the existence of funds in an account of the payer and/or may cause a debit and credit of funds between accounts of the payer and payee. In various embodiments, the PF 130 may perform the debit or credit, or may make a request for the debit or credit from another entity, such as the credit card system 170 or the bank 180.

In another embodiment, the PF 130 may be configured to provide payment information such that the payee may perform subsequently perform the actual payment themselves. For example, the PF may provide a credit card number (or other payment account number) for the payer as part of an authorization confirmation to the payee. The payee may subsequently use the credit card number to perform a payment from the payer to the payee, such as in accordance with traditional payment techniques. In such embodiments, the DBA 100 may thus act as a firewall or clearing house to provide financial information (such as account information) to a payee, but only after the release of such information has been authorized by the payer. Various other techniques for facilitating or performing payments may be understood by those of skill in the art.

After facilitation of payment, at operation 260 the PF 130 (or other module of the DBA 100) may confirm the performance of the payment with the payer and/or the payee. As discussed above, in some embodiments, rather than confirmation of an already-performed payment, the DBA may send financial information (such as account information) which may be used by the payee to perform a payment. Process 200 may then end.

Referring now to FIG. 3, an example process 300 for setting up device-based payment authorization is illustrated in accordance with various embodiments. While FIG. 3 illustrates particular operations in a particular order, in various embodiments, the operations may be combined, split into parts, and/or omitted. In various embodiments, the operations described in process 300 may be performed as one or more implementations of operation 210 of process 200. The process may begin at operation 310, where the payer may register identifying information and/or payment information with the AS 110. In various embodiments, the identifying information may include communication addresses, such as phone numbers, IP addresses, email addresses, etc., that facilitate the DBA 100 in recognizing the identity of the payer when entered by the payee into the payee device 150 and in contacting the payer via the payer device 160.

In alternative embodiments, the payment information may include payment information, such as credit/debit card account number, checking account number, etc. In such embodiments, instead of the payee entering in a credit/debit account number (or other account information), the payee may need only enter a phone number or other identifying information for the payee. This may facilitate payments without requiring sharing of sensitive account information with the payee.

Next, at operation 320, the payer may register payment preferences with the DBA 100. For example, the payer may register a payment threshold over which a signature is required for authorization—below this threshold the DBA 100 may authorize payments based on a PIN or other type of authorization. In other embodiments, the payer may register a preference that a payment above (or below) a predetermined amount should be made from a particular account. In another example, the payer may register a preference for which devices of the payer are used to authorize different types of payments, or payment amounts. After registration of identifying, payment information and preferences, at operation 330, the AS 110 may create an account for the vendor (or update an account if the account had previously been created). The process may then end.

It may be noted that, in the example of FIG. 3, operations are described with reference to the payer; in other embodiments, the payee may be facilitated by the AS 110 of the DBA 100 in performing similar operations, such as registering identifying information for the payee (such as phone numbers or other communication addresses) and or registration of payment information/preferences. In addition, in various embodiments, the payee may be facilitated by the AS 110 in registering account information, such as debit/credit or checking account information. This information may be stored and later used during facilitation of payments to the payee. In other embodiments, this information may not be stored, but may instead be provided by the payee as part of a payment request.

Referring now to FIG. 4, an example process for receiving a payment request is illustrated in accordance with various embodiments. While FIG. 4 illustrates particular operations in a particular order, in various embodiments, the operations may be combined, split into parts, and/or omitted. In various embodiments, the operations described in process 400 may be performed as one or more implementations of operation 230 of process 200. The process may begin at operation 410, where the payee may provide payment information for a payment request. In various embodiments, the payment information may include account information such as credit/debit card account number or checking account number of the payer, etc., a payment amount, a description of a transaction underlying the payment, and/or other payment information. In various embodiments, the payment information may be provided by various means, e.g., through the use of the payee device, as discussed above, such as by swiping or entering a credit or debit card or checking account number of a payer. Next, at operation 420, the payee may enter identifying information for the payer. For example, a phone number, an email address, a name, login information, etc. In various embodiments, the identifying information and/or the payment information may be information that has previously been registered with the DBA 100. Similar to the provision of payment information, the identifying information may be provided through the payee device, such as through a keyboard or number pad. Next, at operation 430, the payment device 150 may send a payment request to the DBA, such as by sending a request to the RA 120 of the DBA 100. After sending the payment request to the DBA 100 at operation 450, the process may end.

Referring now to FIG. 5, an example process 500 for requesting and receiving authorization for a payment is illustrated in accordance with various embodiments. While FIG. 5 illustrates particular operations in a particular order, in various embodiments, the operations may be combined, split into parts, and/or omitted. In various embodiments, the operations described in process 500 may be performed as one or more implementations of operation 240 of process 200. The process may begin at operation 510, where the RA 120 may confirm that an account exists for the payer, such as by confirming information stored by the AS 110. In various embodiments the account may be confirmed based on identifying information of the payer that was received in the payment request message. For example, if the payment request message contains only a credit card number (or other financial information), the RA 120 may confirm that a phone number (or other communication address) for the customer is known to the AS 110 of the DBA 100, in order that the customer may be contacted for authorization.

In another example, if the phone number of the customer is received in the payment request message, then at operation 510 the RA 120 may confirm that a credit/debit card account or other financial information of the payer is known to the AS 110 in order that a payment may be performed from the account of the customer. Such a scenario may provide for payment by the payer to the payee with the payer sharing only identifying information and not sensitive account information with the payee.

In another embodiment, where both a communication address and a credit card number (or other financial information) of the payer are received in the payment request message, the RA 120 may not need to confirm any additional information and may proceed with the information received in the request. Next, at operation 515, the RA 120 may identify the payer device 160. In some embodiments, the payer device 160 may be identified as a single device associated with the payer, who may be identified from the identification information received in the payment request. In other embodiments, the payer device may be identified based on preferences of the payer. For example, the payer may request that all payments over a certain value go to a home desktop computer, while other payments may go to a mobile device.

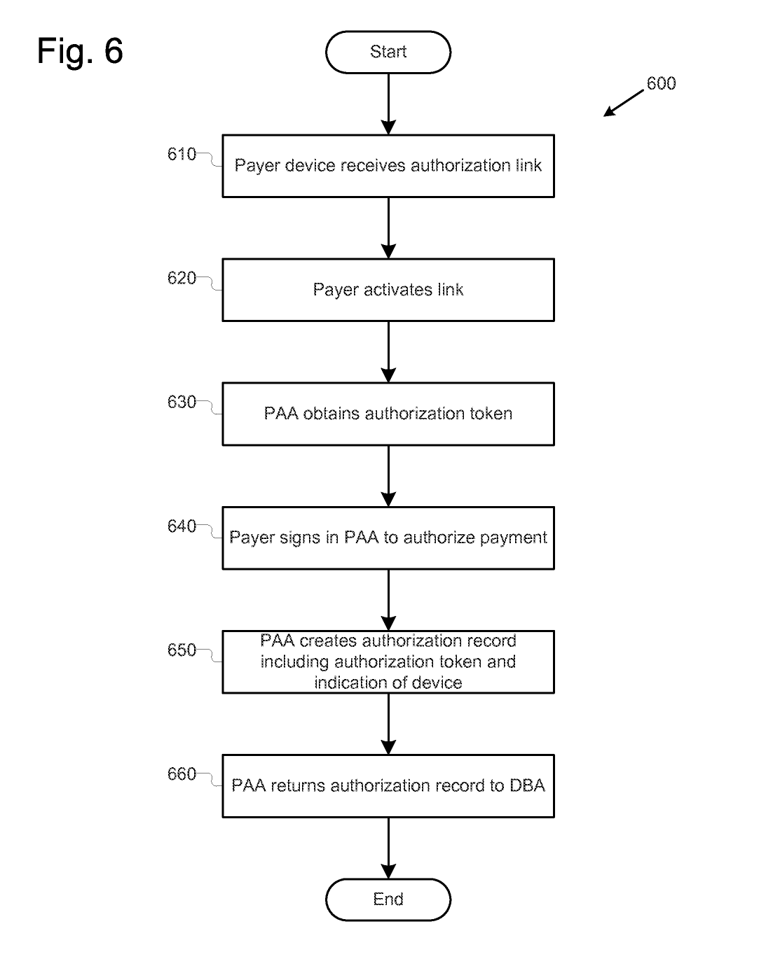

Next, at operation 520, the RA 120 may create an authorization token for the payment requested. As discussed above, in some embodiments, the authorization token may be a unique (or relatively uncommon) value associated with one or more of the particular payee, payer, and/or payment being requested. Next, at operation 530, the RA 120 may send an authorization request to the payer device. In some embodiments, the authorization request is a link, such as sent in an SMS or MMS, that may cause the PAA 165 to execute upon activation. However, in other embodiments, at operation 530, the authorization request may include API or other programmatic calls for the PAA 165, or other request techniques. Next, at operation 540, the PAA 165, along with the RA 120, may perform the requested authorization on the payer device 160 and cause an authorization record to be returned to the RA 120. Particular examples of operation 540 may be described below with reference to process 600 of FIG. 6.

Next, at operation 550, the RA 120 may confirm that the authorization is confirmed as trustworthy, such as by comparing a received authorization token to a copy of the authorization token stored before sending the authorization request, and/or by comparing the IMEI number to identifying information for the payer. After the authorization is confirmed, at operation 560, the RA 120 may record the received authorization record. For example, if the authorization record includes an image of a signature performed on the payer device or data describing a 3D signature performed using the payer device, then that image may be stored and maintained at operation 560. In other embodiments, other records may be stored, such as time and date of authorization, place of authorization, etc. After performance of operation 560, the process may then end.

Referring now to FIG. 6, an example process for receiving authorization for a payment is illustrated in accordance with various embodiments. While FIG. 6 illustrates particular operations in a particular order, in various embodiments, the operations may be combined, split into parts, and/or omitted. In various embodiments, the operations described in process 600 may be performed as one or more implementations of operation 540 of process 500. It may be noted that the particular examples illustrated in process 600 are for embodiments where the authorization request includes a link; in other embodiments, process 600 may be modified to operate with other types of authorization requests, as described below. The process may begin at operation 610, where the payer device 160 may receive an authorization request message including a link to activate the PAA 165. Next, at operation 620, the payer may activate the link, causing the PAA 165 to perform an authorization facilitation.

At operation 630, the PAA 165 may obtain the authorization token provided by the RA 120 during generation of the authorization request. In some embodiments, the authorization token may be included in the link provided in the authorization request, and may simply be obtained as part of the authorization request activation. In other embodiments, the PAA 165 may communicate with the RA 120 in order to request and receive the authorization token in a separate communication. In some embodiments, such as where the authorization request does not include a link, different methods of obtaining the authorization token may be used, such as including the authorization token in a programmatic call, or including a URL or other identifier where the authorization token may be obtained from.

Next, at operation 640, the payer may perform a signature on the payer device 160 using the PAA 165 to perform the authorization for the payment. In other embodiments, a signature may not be used for authorization, and instead a password or PIN may be input into the PAA 165, or a gesture may be performed by the payer using the payer device 160. Next, at operation 650, the PAA 165 may create an authorization record. In various embodiments, the authorization record may include a record of the performance of the authorization, such as an image of the signature performed on the payer device 160, data describing a 3D signature performed using the payer device 160, or other information related to the authorization. In various embodiments, the authorization record may also include the previously-obtained authorization token. After creation of the authorization token, the PAA 165 may then return the authorization record to the DBA 100. The process may then end.

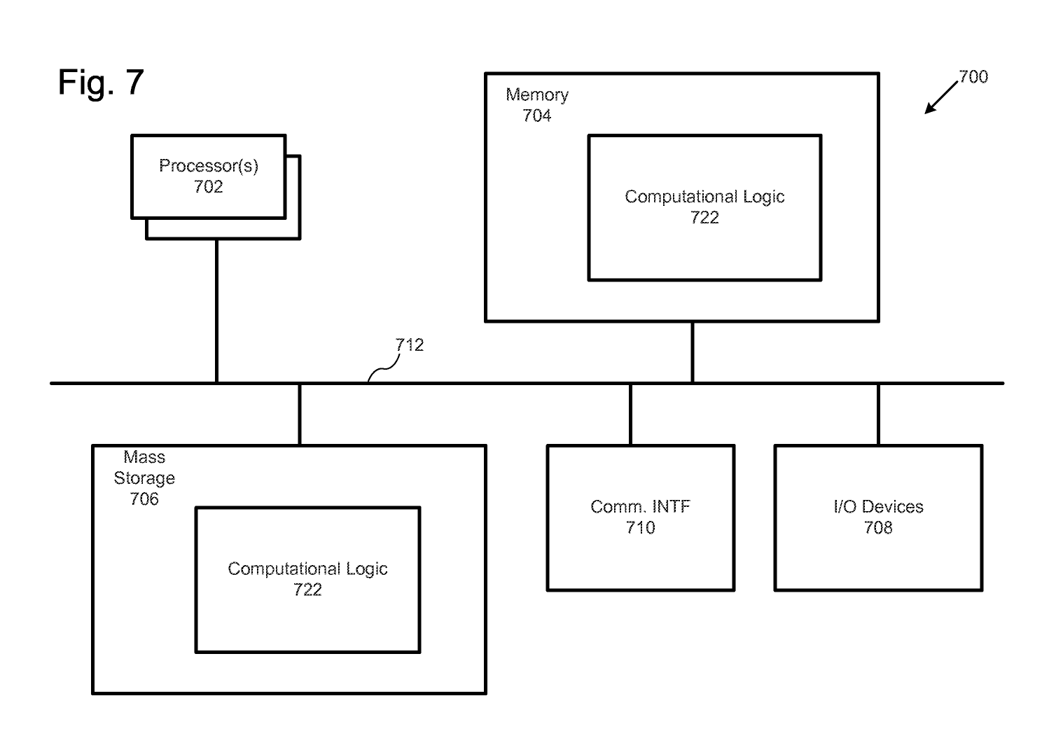

Referring now to FIG. 7, an example computer suitable for practicing various aspects of the present disclosure, including processes of FIGS. 2-6, is illustrated in accordance with various embodiments. As shown, computer 700 may include one or more processors or processor cores 702, and system memory 704. For the purpose of this application, including the claims, the terms “processor” and “processor cores” may be considered synonymous, unless the context clearly requires otherwise. Additionally, computer 700 may include mass storage devices 706 (such as diskette, hard drive, compact disc read only memory (CD-ROM) and so forth), input/output devices 708 (such as display, keyboard, cursor control, remote control, gaming controller, image capture device, and so forth) and communication interfaces 710 (such as network interface cards, modems, infrared receivers, radio receivers (e.g., Bluetooth), and so forth). The elements may be coupled to each other via system bus 712, which may represent one or more buses. In the case of multiple buses, they may be bridged by one or more bus bridges (not shown).

Each of these elements may perform its conventional functions known in the art. In particular, system memory 704 and mass storage devices 706 may be employed to store a working copy and a permanent copy of the programming instructions implementing the modules shown in FIG. 1, and/or the operations associated with various aspects of the techniques shown in FIGS. 2-6, collectively referred to as computing logic 722. The various elements may be implemented by assembler instructions supported by processor(s) 702 or high-level languages, such as, for example, C, that can be compiled into such instructions.

The permanent copy of the programming instructions may be placed into permanent storage devices 706 in the factory, or in the field, through, for example, a distribution medium (not shown), such as a compact disc (CD), or through communication interface 710 (from a distribution server (not shown)). That is, one or more distribution media having an implementation of the agent program may be employed to distribute the agent and program various computing devices. In embodiments, the programming instructions may be stored in one or more computer readable non-transitory storage media. In other embodiments, the programming instructions may be encoded in transitory storage media, such as signals.

The number, capability and/or capacity of these elements 710-712 may vary, depending on whether computer 700 is used as payee device 150, payer device 160, or a server for DBA 100. Their constitutions are otherwise known, and accordingly will not be further described. Accordingly, depending on usage of computer 700, it may be a smartphone, a computing tablet, a laptop computer, an e-reader, a game console, a set-top box, a desktop computer, or a server.

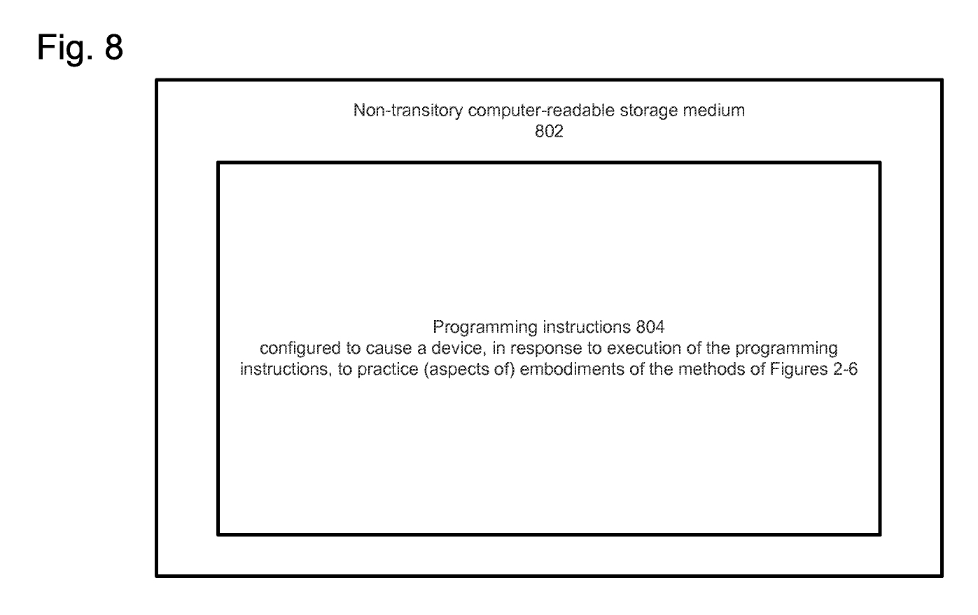

FIG. 8 illustrates an example least one computer-readable storage medium 802 having instructions configured to practice all or selected ones of the operations associated with the techniques earlier described, in accordance with various embodiments. As illustrated, least one computer-readable storage medium 802 may include a number of programming instructions 804. Programming instructions 804 may be configured to enable a device, e.g., computer 700, in response to execution of the programming instructions, to perform, e.g., various operations of processes of FIGS. 2-6, e.g., but not limited to, to the various operations performed to perform device-based authorization of payments. In alternate embodiments, programming instructions 804 may be disposed on multiple least one computer-readable storage media 802 instead.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer-readable media comprising instructions to cause a computing system, in response to execution by the computing system, to facilitate payment authorization, wherein the computing system is caused to:
receive a request to facilitate a first party in making a payment to a second party, wherein the request message includes identifying information for the first party;
provide an authorization request to a device of the first party;
receive an authorization record from the device of the first party, wherein the authorization record records indications of an authorization performed by the first party using the device of the first party; and
facilitate payment from the first party to the second party from an account associated with the first party.

2. The computer-readable media of claim 1, wherein receive a request comprises receive a request including a payment account number for a payment account of the first party.

3. The computer-readable media of claim 2, wherein the payment account number comprises a credit or debit card number.

4. The computer-readable media of claim 1, wherein:
the device of the first party comprises a mobile phone; and
the identifying information for the first party comprises a telephone number for the mobile phone.

5. The computer-readable media of claim 1, wherein the identifying information for the first party comprises a communication address associated with the device of the first party or an account associated with the device of the first party.

6. The computer-readable media of claim 1, wherein:
provide an authorization request comprises provide an authorization request that includes an authorization token; and
receive an authorization record from the device comprises receive an authorization record that includes the provided authorization token.

7. The computer-readable media of claim 1, wherein receive an authorization record from the device comprises receive an authorization record that includes a unique identifier of the device of the first party.

8. The computer-readable media of claim 1, wherein the authorization record comprises a signature performed using the device of the first party.

9. The computer-readable media of claim 8, wherein the authorization record comprises a copy of an image of a signature entered the device of the first party, or data describing a 3D gesture signature performed using the device of the first party.

10. The computer-readable media of claim 1, wherein the computer system is further caused to store the authorization record for later retrieval.

11. The computer-readable media of claim 1, wherein facilitate payment comprises request debit from the account associated with the first party and a credit to an account associated with the second party.

12. The computer-readable media of claim 1, wherein facilitate payment comprises provide information for the account associated with the first party to the second party.

13. An apparatus for facilitation of payment authorization, the apparatus comprising:
one or more computer processors; and
logic to operate on the one or more computer processors to:
receive a request to facilitate a first party in making a payment to a second party, wherein the request message includes identifying information for the first party;
provide an authorization request to a device of the first party;
receive an authorization record from the device of the first party, wherein the authorization record records indications of an authorization performed by the first party using the device of the first party; and
facilitate payment from the first party to the second party from an account associated with the first party.

14. The apparatus of claim 13, wherein receive a request comprises receive a request including a payment account number for a payment account of the first party.

15. The apparatus of claim 13, wherein:
the device of the first party comprises a mobile phone; and
the identifying information for the first party comprises a telephone number for the mobile phone.

16. The apparatus of claim 13, wherein the identifying information for the first party comprises a communication address associated with the device of the first party or an account associated with the device of the first party.

17. The apparatus of claim 13, wherein provide an authorization request comprises provide an authorization request that includes an authorization token; and.

18. The apparatus of claim 17, wherein receive an authorization record from the device comprises receive an authorization record that includes the provided authorization token.

19. The apparatus of claim 13, wherein receive an authorization record from the device comprises receive an authorization record that includes a unique identifier of the device of the first party.

20. The apparatus of claim 13, wherein the authorization record comprises a signature performed using the device of the first party.

21. The apparatus of claim 20, wherein the authorization record comprises a copy of an image of a signature entered the device of the first party, or data describing a 3D gesture signature performed using the device of the first party.

22. A method for facilitation of payment authorization, the method comprising:
receiving, by a computing system, a request to facilitate a first party in making a payment to a second party, wherein the request message includes identifying information for the first party;
providing, by the computing system, an authorization request to a device of the first party;
receiving, by the computing system, an authorization record from the device of the first party, wherein the authorization record records indications of an authorization performed by the first party using the device of the first party; and
facilitating, by the computing system, payment from the first party to the second party from an account associated with the first party.

23. The method of claim 22, wherein receiving a request comprises receiving a request including a payment account number for a payment account of the first party.

24. The method of claim 22, wherein:
the device of the first party comprises a mobile phone; and
the identifying information for the first party comprises a telephone number for the mobile phone.

25. The method of claim 22, wherein the identifying information for the first party comprises a communication address associated with the device of the first party or an account associated with the device of the first party.

26. The method of claim 22, wherein providing an authorization request comprises providing an authorization request that includes an authorization token; and.

27. The method of claim 26, wherein receiving an authorization record from the device comprises receiving an authorization record that includes the provided authorization token.

28. The method of claim 22, wherein receiving an authorization record from the device comprises receiving an authorization record that includes a unique identifier of the device of the first party.

29. The method of claim 22, wherein receiving an authorization record comprises receiving a signature performed using the device of the first party.

30. The method of claim 29, wherein receiving a signature comprises receiving a copy of an image of a signature entered the device of the first party, or data describing a 3D gesture signature performed using the device of the first party.
